(19) United States
(12) Patent Application Publication
(10) Pub. No.: US 2003/0184360 A1
(43) Pub. Date: Oct. 2, 2003

(54) CHARGE PUMP FOR FLASH MEMORY WITH SERIALLY CONNECTED CAPACITORS FOR PREVENTING BREAKDOWN

(76) Inventors: Yi-Ti Wang, Tainan Hsien (TW); Wei-Wu Liao, Taipei Hsien (TW); Wen-Shih Shu, Peng-Hu Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/248,045

(22) Filed: Dec. 12, 2002

(30) Foreign Application Priority Data
Mar. 29, 2002 (TW) 091106234

(51) Int. Cl. G05F 1/10

(52) U.S. Cl. 327/536

(57) ABSTRACT

A charge pump for a flash memory. The charge pump includes: a current-guiding circuit having a first, a second, and a third output; and a first, a second, and a third charge unit. The current-guiding circuit has two diode-connected transistors respectively connected between the first and the second outputs, and the second and the third outputs. Each of the charge units, for storing charge, has two ends. The first, the second, and the third charge units respectively have one end connected to the first, the second, and the third outputs, and the other end of the third charge unit is connected to the first output.

### BACKGROUND OF INVENTION

1. Field of the Invention

The invention relates to a charge pump for a flash memory, more specifically a charge pump connected serially with capacitors to prevent the oxide layer from breakdown.

2. Description of Background

Of all kinds of nonvolatile memory devices, flash memory, accessed, read, or written electrically, came to be one of the most valued nonvolatile memory types in the electronics industry. The flash memory stores digital data by MOS transistors with a floating gate. The floating gates are fabricated in an oxide layer of the MOS transistors. When the flash memory programs data, electrons will go through oxide layer to be stored in the floating gates so that the aim of storing nonvolatile data will be achieved. The flash memory is capable of accessing data electrically, unlike a hard disc that is operated mechanically, so that there are advantages of size and speed of operation, etc.

Regardless whether electrons go from the oxide layer to the floating gate when the flash memory programs data or the electrons move away from the floating gates while erasing data, it takes a considerably high drive voltage to cause tunneling. The drive voltage is usually higher than a bias voltage of a normal digital logic circuit. Such being the case, there is need for the flash memory to use a specific circuit to generate the high drive voltage. Generally speaking, the bias voltage of the logic circuit of the flash memory is around 3V, or even lower, but the voltage required for tunneling is often up to 10V, or even higher. Therefore, the charge pump generating the high drive voltage has special structures.

Please refer to FIG. 1, which shows a circuit diagram of a conventional charge pump 10 of a flash memory. The charge pump 10 comprises a current-guiding circuit 12, a plurality of capacitors for charge units (four capacitors Cp1 to Cp4 are marked in FIG. 1), and a capacitor unit CLp of equivalent load for simulating load effect. In accordance with the five capacitors Cp1 to Cp4 and CLp, there are also five N-type MOS transistors T1 to T5 installed in the current-guiding circuit 12. Each transistor functions as a diode being a current-guiding unit. A drain of each transistor is connected to a gate and is a positive electrode. A source of each transistor is a negative electrode and is also an output end of the current-guiding circuit 12. The whole sum of the output ends in current-guiding circuit 12 is five and they are the nodes Np1 to Np5 respectively.

As FIG. 1 shows, each output end is connected to one end of a capacitor; the other end of the capacitors Cp1 and Cp3 are connected to a clock CK+ and the other end of the capacitors Cp2 and Cp4 are connected to a clock CK−. The drain of the transistor T1 is connected to a direct current source for providing bias voltage Vdd. The node Np5 is connected to one end of the capacitor CLp and is taken as a load output end. The other end of the capacitor CLp is connected to ground. A voltage Vp0 across the capacitor CLp is the drive voltage which the charge pump 10 is able to provide.

Because there is a transistor serving as a current-guiding unit connected between each output in current-guiding circuit 12, there must be a corresponding relation between each output. For instance, the node Np1 corresponds to the node Np2, and when the voltage on the node Np1 is higher than the voltage on the node Np2 by a threshold voltage Vt, the transistor T2 can conduct current from the node Np1 to Np2. On the other hand, when the voltage on the node Np1 minus the voltage of the node Np2 is lower than the threshold voltage Vt or even the voltage on the node Np2 is higher than that on the node Np1, the transistor T2 cannot conduct current from the node Np2 to the node Np1.

In other words, when the voltage on the node Np1, Np2, Np3, or Np4 is higher by the threshold voltage Vt than the node Np2, Np3, Np4, or Np5 respectively, the transistor T2, T3, T4, and T5 can be turned on to conduct current to the node Np2, Np3, Np4, and Np5. On the other hand, the node Np2, Np3, Np4, or Np5 cannot conduct current back to the node Np1, Np2, Np3, or Np4 through the reverse-bias transistor T2, T3, T4, or T5.

In addition, the clock CK+ and the clock CK− are opposite high frequency clocks. In other words, while the clock CK+ is at a high voltage level, the clock CK− is at a low voltage level, and while the clock CK+ is at a low voltage level, the clock CK− is at a high voltage level. The high voltage level voltage of the two clocks is usually the voltage of the bias Vdd, and the low voltage level is voltage on ground (that is the voltage is zero).

Please refer to FIG. 2 (also refer to FIG. 1), which shows the table of the voltage on each node changing with time while the charge pump 10 is working. The vertical axis of FIG. 2 means time; each column 14A to 14E means the voltage on each node Np1 to Np5 respectively, and “H” and “L” means that the voltage level condition of the clock CK+ and the clock CK− is at high voltage level (voltage Vdd) or at low voltage level (zero voltage) respectively. The two clocks exchanging once from a high voltage level to a low voltage level is a cycle T.

Suppose that before a time point tp0 there is no stored charge in each capacitor. When the clock CK− rises up to the high voltage level “H” at the time point tp0, the voltage of the two ends of capacitor Cp2 and Cp4 will both rise to the voltage Vdd simultaneously. Therefore, the voltage on the nodes Np2 and Np4 will both also rise up to the voltage Vdd at the same moment. When the clock CK+ is at the low voltage level “L”, the voltage of both ends of the capacitors Cp1, Cp3 will not change.

The voltage of the drain of the transistor T1 and the voltage on the nodes Np2 and Np4 is respectively higher than the voltage on the nodes Np1, Np3, and Np3 and make the transistors T1, T3, and T5 conduct current from the nodes Np1, Np3, and Np5 charging the capacitors Cp1, Cp3, and CLp. With the increasing charge in the capacitors Cp1, Cp3 and CLp, the voltage on the nodes Np1, Np3 and Np5 will increase to a range of a voltage dV.

The charge pump 10 not only utilizes the changing moment of voltage levels of the clock CK+ and the clock CK− to raise the voltage of both ends of each capacitor simultaneously, but also make use of a voltage difference between each output in current-guiding circuit 12 to accumulate charge. Consequently, the frequency of the clocks CK+ and CK− is quite high and the cycling between the high and low voltage levels being so rapid that we can a generate voltage difference frequently by the utilization of the changing moment of voltage level. Because the time which the clock CK− remains at the high voltage level within the interval between time tp0 and tp1 is very short, the capacitors Cp1, Cp3 and CLp can be charged a corresponding charge of voltage dV (voltage dV is usually far lower than voltage Vdd and threshold voltage Vt).

The clock CK+ rises to the high voltage level and the clock CK− falls down to the low voltage level at the time tp1. Then the clock CK+ will raise both ends of the capacitors Cp1 and Cp3 to the voltage Vdd. Simultaneously the voltage on the nodes Np1 and Np3 will be Vdd+dV (voltage dV is the corresponding one which capacitor Cp1 and Cp3 are charged in the period of time tp0, tp1.).

The clock CK− will lower the voltage in both ends of the capacitors Cp2 and Cp4 simultaneously to zero voltage at the time tp1. Then, the voltage on the nodes Np1 and Np3 is higher than the voltage on the nodes Np2 and Np4 respectively so that the transistors T2 and T4 conduct current to the nodes Np2 and Np4 for charging the capacitors Cp2 and Cp4. The voltage of the node Np4 is not higher than the voltage of the node Np5 by the threshold voltage and transistor T5 will not be conductive. Therefore, the capacitor CLp connected to the node Np5 will not be charged. The capacitors Cp2 and Cp4 will be charged corresponding to the voltage dV at the time tp2. Because one end of the capacitors Cp2 and Cp4 is connected to the clock CK− and the clock CK− is at a low voltage level (zero voltage), then the voltage generated by stored charge causes the voltage on the nodes Np2, Np4 to rise up by the voltage dV.

At the time tp2, the clock CK+ will be at the low voltage level and the clock CK− will be at the high voltage level again. The clock CK+ brings the voltage of both ends of the capacitors Cp1 and Cp3 to fall by the voltage Vdd simultaneously so that the voltage on the nodes Np1 and Np3 reduces to the voltage of the time tp1. At the same time, the clock CK− brings the voltage of both ends of the capacitors Cp2 and Cp4 up by in voltage Vdd along with the voltage dV which corresponds to the stored charge in the capacitors Cp2 and Cp4 in the periods of the time tp1 and tp2, making the voltage on the nodes Np2 and Np4 rise to voltage Vdd+dV.

Because of the reduction in voltage on the nodes Np1, Np3, and Np5 and the rise in voltage on the nodes Np2 and Np4, the transistors T1, T3, and T5 will turn on to charge the capacitors Cp1, Cp3, and CLp by a voltage dV, and the voltage of the capacitors Cp1, Cp3 and CLp to which the stored charge corresponds has risen by the voltage 2 dV along with the charge which is charged in the period of the time tp0 to tp1.

With the continuous change of the voltage level of the clocks CK+ and CK−, each capacitor in the charge pump 10 also accumulates charge constantly until the voltage difference of each output end in the current-guiding circuit 12 and its corresponding output end is lower than the threshold voltage Vt. For instance, the capacitors Cp1, Cp3, and CLp have been charged by the voltage that corresponds to the voltage Vdd−Vt at the time tp3 and the charge in the capacitor Cp1 is in a steady state at the time tp4. The voltage difference of both ends of the transistor T1 is lower than the threshold voltage meaning the capacitor Cp1 will not be charged anymore. For this reason, the corresponding voltage of charge in steady state in the capacitor Cp1 is voltage Vdd−Vt.

However, the voltage of the node Np2 will still be brought to rise by the high voltage level of the clock CK− to make it higher than the voltage of the node Np3 in excess of the threshold voltage. Therefore, the transistor T3 will be turned on to conduct electricity to charge the capacitor Cp3, and the transistor T5 will be turned on to conduct electricity to charge the capacitor CLp continuously for the same reason. The voltage to which the stored charge corresponds in the capacitor Cp2 is up to a voltage 2 Vdd−2 Vt at the time tp5. Even though the clock CK+ causes the voltage on the node Np1 to rise to voltage 2 Vdd−Vt, the voltage difference between the nodes Np1 and Np2 will not be over the threshold voltage making the charge stored in the capacitors Cp3 and Cp4 in a steady state, not increasing continuously.

For the same reason, the charge stored in the capacitors Cp3 and Cp4 will also be in a steady state in turns. The charge in each capacitor is in a steady state at the time tp6. Although the clock CK− causes the voltage on the nodes Np2 and Np4 to rise, the voltage difference between the nodes Np2 and Np3 and the nodes Np4 and Np5 will not exceed the threshold voltage so that the capacitors Cp3 and CLp will not be charged. For the same reason, although the clock CK+ causes the voltage on the nodes Np1 and Np3 to rise, the voltage difference between the nodes Np1 and Np2 and the nodes Np3 and Np4 will not surpass the threshold voltage so that it will not turn on the transistors T2 and T4 to charge the capacitors Cp2 and Cp4.

The voltage of the capacitors Cp1, Cp2, Cp3, and Cp4 to which the stored charge in a steady state corresponds is the voltage Vdd−Vt, 2 Vdd−Vt, 3 Vdd−Vt and 4 Vdd−Vt respectively, and the voltage of the equivalent load capacitor is able to be accumulated to 5 Vdd−Vt for a output voltage provided by charge pump 10. The voltage 5 Vdd−Vt usually is higher than the voltage Vdd bias voltage. More capacitors and corresponding transistors can be used to increase the output voltage if desired.

The defects of the conventional charge pump 10 in FIG. 1 can be explained as follows. First, the charge in steady state necessarily stored in each capacitor Cp1 to Cp4 as a charging unit within charge pump 10 is more and more. The corresponding voltage on the stored charge in the capacitor Cp4 is at 4 Vdd−Vt. If some other charge units are deposited within the charge pump 10, the closer capacitor is to the load output end, the more charge is charged into the capacitor in a steady state.

As known to those skilled in the art, an oxide layer separating two conducting layers produces charge. The more stored charge in the capacitor, the larger the net voltage between the two conducting layers. When the net voltage grows too high, the oxide layer will breakdown, which destroys the isolation faculty of oxide layer and therefore the capacitor cannot store charge normally.

In the conventional charge pump 10, in order to provide a high input voltage, the charge unit which is closer to the load output end needs to store more charge in a steady state, which tends to breakdown the oxide layer of that charge unit, disabling the charge pump 10 from appropriate performance. Furthermore, the conventional charge pump 10 uses n-type MOS transistors T1 to T5 as flow conducting units. As known to those skilled in the art, n-type MOS transistor is usually formed on a shared p-type substrate, which is the shared body electrode and is usually the ground of n-type MOS transistor.

As shown in FIG. 1, the body electrode of each transistor T1 to T5 grounds through the same p-type substrate, which results in a body electrode effect, causing a difference of the threshold voltages on each of the transistors T1 to T5, thus making circuit design and performance difficult, and what is worse, tends to breakdown the transistors.

Please refer to FIG. 2, take the transistor T5 as the closest to the load output end for example. The voltage on the source that connects with the node NP5 may rise up to 5 Vdd−Vt. The voltage on the drain of the transistor T5 that connects with node Np4 may rise up to 5 Vdd−Vt, but the body electrode of the transistor T5 remains grounded at 0 volts. Therefore, the excessive net voltage on the source-body electrode and drain-body electrode makes the transistor T5 breakdown, disabling the conventional charge pump 10 from normal performance.

### SUMMARY OF INVENTION

A primary objective of the claimed invention is to provide a charge pump using serial capacitors and p-type MOS transistors for a current-guiding unit in a charge pump to avoid breakdown of the capacitors and the transistors.

In the claimed invention, the voltage on each input of current-guiding circuit is collectively maintained by the charge accumulated in several capacitors. In spite of the voltage on each output increasing as the output gets closer to the load output, the charge stored in the corresponding capacitor does not rise, which maintains normal performance of each capacitors.

### BRIEF DESCRIPTION OF DRAWINGS

FIG. 1 is circuit diagram of a charge pump according to the prior art.

FIG. 2 is a table of voltage versus time, of each node concerned while the charge pump of FIG. 1 is performing.

FIG. 3 is circuit diagram of the first embodiment of a charge pump according to the present invention.

FIG. 4 is a table of voltage on each node when the charge pump shown in FIG. 3 is in steady state.

FIG. 5 is a schematic diagram of a connection rule according to the present invention.

FIG. 6 is a circuit diagram of the second embodiment of charge pump according to the present invention.

FIG. 7 is a circuit diagram of the realized charge pump of FIG. 6 FIG. 8 is a circuit diagram of the third embodiment of charge pump according to the present invention.

FIG. 9 is a circuit diagram of the fourth embodiment of charge pump according to the present invention.

### DETAILED DESCRIPTION

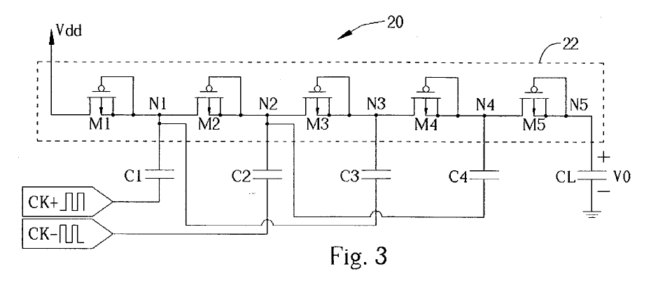

Please refer to FIG. 3, a circuit diagram of an embodiment of the invention charge pump 20. The charge pump 20 comprises a current-guiding circuit 22, capacitors C1 to C4 as charge units, a capacitor CL as a load component, a equivalent load simulating charge pump 20, and the voltage across capacitor CL, that is, output voltage V0 that can be provided by charge pump 20. For each capacitor C1 to C4 and CL, the current-guiding circuit 22 also comprises a p-type MOS transistor M1 to M5 respectively, of which each as a current-guiding unit functions a diode with a source as positive electrode, a drain as negative electrode, and a gate that connects with the drain. When the positive voltage on the transistor in a current-guiding unit exceeds the negative voltage by a threshold voltage, that transistor will turn on, which allows current to pass from the positive electrode to the negative electrode. On the other hand, when the positive electrode voltage does not exceed the negative voltage by the threshold voltage, the current-guiding unit will not turn on.

The source (the positive electrode) of the transistor M1 connects with the direct current supply of voltage Vdd. The negative electrode of each current-guiding unit is the output electrode of the current-guiding circuit 22. Hence, there are nodes N1 to N5 as the output electrodes in the current-guiding circuit 22. Nodes N1 to N4 connect with an electrode of the capacitors C1 to C4 respectively, and node N5, as a load output electrode, connects with the capacitor CL of the load component. The other electrode of the capacitor C1 connects with the clock CK+, and that of the capacitor C2 connects with the clock CK−. Different from the prior art, the other electrode of the capacitor C3 connects with the node N1 but not directly to the clock. Similarly, the other electrode of the capacitor C4 connects with the node N2. The clocks CK+ and CK− are, akin to the conventional charge pump 10, at opposite phase.

Similar to the conventional charge pump 10, the present invention charge pump 20 turns on by the transitory change of the voltage on each node due to the alternating clock CK+ and CK−. The alternation causes the voltage between the positive and negative electrode of each current-guiding unit to surpass the threshold voltage Vt of the transistor in the current-guiding unit, and thus the charging current toward the negative electrode charges the capacitor C1 to C4 and further raises the voltage of each node. It continues until the voltage between the positive and negative electrode of each current-guiding unit does not surpass the threshold voltage, and then the charge in each capacitor reaches a steady state.

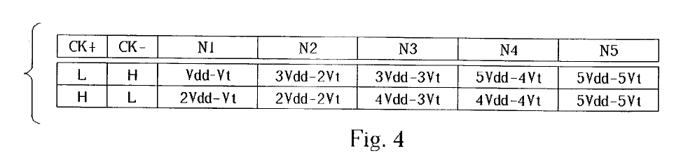

Please refer to FIG. 4. It is a table of voltage on each node N1 to N5 as per the clock when the charge of each capacitor in the charge pump 20 is in steady state. When the clock CK+ is at zero voltage, the low voltage level, presented as L in FIG. 4, and the clock CK− is at Vdd, the high voltage level, presented as H in FIG. 4, the voltage of the nodes N1 to N5 is Vdd−Vt, 3 Vdd−2 Vt, 3 Vdd−3 Vt, 5 Vdd−4 Vt, and 5 Vdd−5 Vt respectively. On the other hand, when the clock CK+ is at the high voltage level and the clock CK− is at the low voltage level, the voltage of the nodes N1 to N5 is respectively 2 Vdd−Vt, 2 Vdd−2 Vt, 4 Vdd−3 Vt, 4 Vdd−4 Vt, and 5 Vdd−5 Vt.

When the charge of each capacitor reaches steady state, although the voltage on each node in the charge pump 20 is in the same situation as that of the conventional charge pump 10, the charge stored in each capacitor in steady state is slashed within the invention charge pump 20. A lower charge effectively prevents the breakdown of each capacitor as a charge unit. Because, in the charge pump 20, the node N3 connects to the clock CK+ through the capacitors C3 and C1, and the voltage on the node N3 equals the voltage across the capacitor C3 and C1 plus the voltage level driven by the clock CK+, even though the voltage on the node N3 rises to 4 Vdd−3 Vt, the voltage of the capacitor C3, whose charge is in steady state, in fact is only 2 Vdd−Vt. Similarly, because the voltage on the node N4 equals the voltage across the capacitor C4 and C2 plus the voltage level driven by the clock CK−, even though the voltage on the node N4 reaches 5 Vdd−4 Vt, the voltage of the capacitor C4, whose charge is in steady state, in fact is only 2 Vdd−2 Vt.

To sum up, within the charge pump 20, the corresponding voltage on the capacitor C1 to C4, whose charge is in steady state, is respectively Vdd−Vt, 2 Vdd−2 Vt, 2 Vdd−2 Vt, and 2 Vdd−2 Vt. Please note that even the capacitor C4, which is closest to the load output electrode, has a voltage corresponding to its maximal stored charge of only 2 Vdd−Vt. Comparatively, within the conventional charge pump 10, the corresponding voltage on the capacitor C1 to C4, whose charge is in steady state, is respectively Vdd−Vt, 2 Vdd−2 Vt, 3 Vdd−3 Vt, and 4 Vdd−4 Vt. As shown by the comparison, the charge unit within the invention charge pump can effectively provide high output voltage without excessive stored charge.

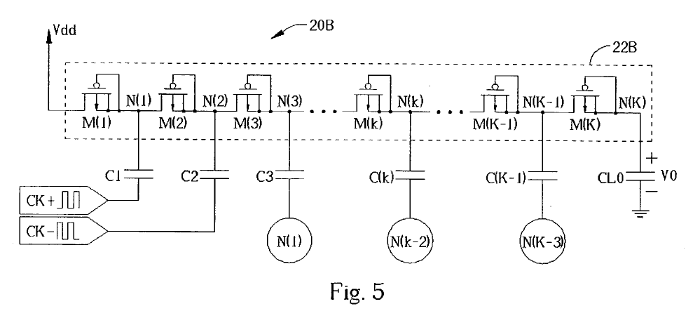

Please refer to FIG. 5. FIG. 5 is the schematic diagram of a common connection rule of an embodiment of the present invention charge pump 20B. In the charge pump 20B, there are K transistors M(1), M(2), . . . , M(K)functioning as diodes as current-guiding units, whose nodes N(1), N(2), N(3), N(K−1) are output electrodes, with N(K) as a load output electrode. The capacitors C(1), C(2), . . . , C(K−1) are as the charge units, with the capacitor CL0 as a load unit.

Each and each unit connects with the corresponding output electrode, such as the capacitor C(1) connects with the node N(1), C(2) with N(2), and the K^{th} capacitor C(K) with the node N(K), until the load output electrode with the capacitor CL0. The other electrode of the capacitors C(1) and C(2) respectively connects with the clocks CK+ or CK−. The other electrode of the K^{th} capacitor C(K) (K>=2) connects with the node N (K−2), which makes the capacitor C(K) in fact connect between the node N(K) and N(K−2). That is, except for the load output electrode, the K^{th} node N(k) connects with the clock CK+ or CK− through the capacitors C(1), C(k), C(K−2), C(K−4), etc. if k is an odd number, or C(2), C(K), C(K−2), C(K−4), etc. if k is an even number, respectively. Furthermore, the clock can promote the voltage on the node N(K) up or down via the capacitors to accumulate charge successively.

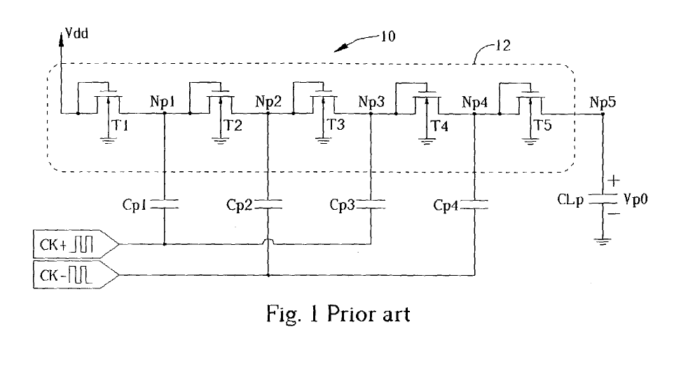

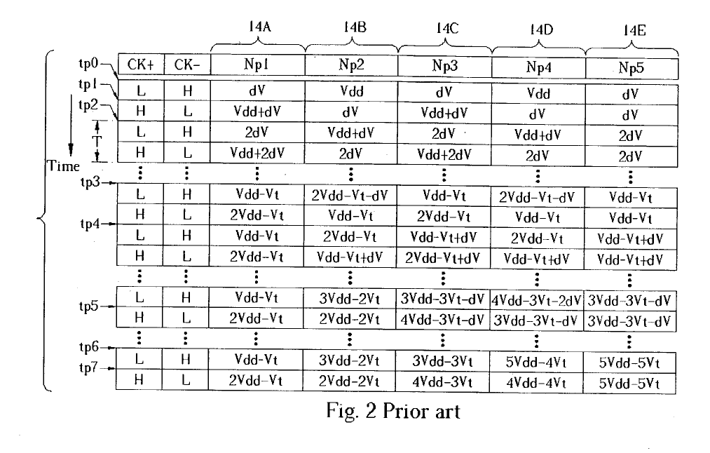

On the other side, voltage on each node N(K) is accumulated by a plurality of capacitors serving as charge units with which each capacitor only stores a portion of the total charge, and the high output voltage is accumulated on the load output end. The closer to load output end the node N(K) is (the larger k is), the more capacitors C (k), C(k−2),C(k−4) and so on are connected serially to the clock. Though the closer node N(K) is to the load output end the more the node N(K) needs a higher accumulated voltage, more capacitors are available to share the accumulated voltage. In fact, in the present invention, the closest charge unit to the load output end only stores charge corresponding to voltage 2 Vdd−2 Vt (as former charge pump 20). By comparison, each charge unit in the prior art charge pump 10 is connected directly to the clock. If the conventional charge pump 10 has L charge units, the closest capacitor to the load output end stores charge corresponding to voltage L(Vdd−Vt). In the conventional charge pump 10 shown in FIG. 1, more charge units with more stored charge are used to accumulate voltage and results in a potential capacitor breakdown.

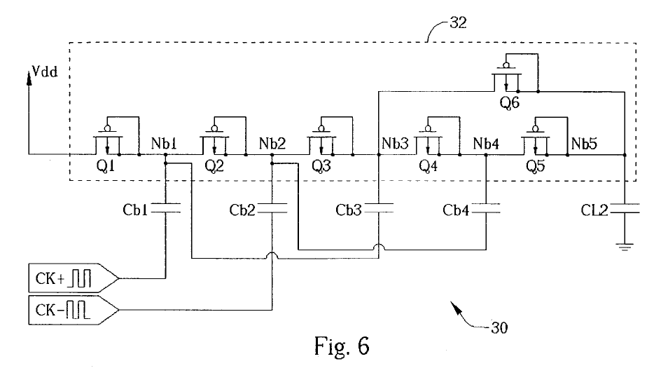

Please refer to FIG. 6. There are four capacitors Cb1, Cb2, Cb3, and Cb4 being charge units, and a load capacitor CL2 for simulating a load effect in a charge pump 60. For matching the four charge units Cb1, Cb2, Cb3, and Cb4, a current-guiding circuit 32 has six p-type MOS transistors Ql, Q2, Q3, Q4, Q5, and Q6 forming diodes for current-guiding units. Nodes Nb1, Nb2, Nb3, Nb4, and Nb5 are output ends wherein Nb1, Nb2, Nb3, and Nb4 are connected to one end of the capacitors Cb1, Cb2, Cb3, and Cb4 respectively. The output end Nb5 is a load output end and is connected with the load capacitor CL2. The capacitors Cb1 and Cb2 are connected to the clocks CK+ and CK−, respectively. The capacitors Cb3 and Cb4 are connected to the nodes Nb1 and Nb2 respectively.

Differing from charge pump 20, the transistor Q6, being another current-guiding unit in charge pump 30, is connected between the nodes Nb3 and Nb5. These connections are capable of reducing the time of charging to the load unit CL2. The charge pump 20 shown in FIG. 3 is capable of charging the load unit CL2 only when the transistor M5 is turn-on. But the charge pump 30 shown in FIG. 6 is capable of charging the load unit CL2 when either the transistor Q5 or Q6 is turned on.

In the duration of each capacitor Cb1 to Cb4 and load capacitor CL2 being charged, while CK− is at the low voltage level, the voltage on the node Nb4 of the transistor Q5 is lower than the voltage on the node Nb5, resulting in the transistor Q5 being incapable of turning on a current for charging the capacitor CL2. At the same time, CK+ being at high voltage level and driving the voltage level of the node Nb3 to rise causes the transistor Q6 to turn-on and charges the capacitor CL2. Similarly, while CK− transforms to the high voltage level and Ck+ transforms to the low voltage level, the transistor Q6 is turned off because of a voltage on the node Nb3 decreasing, but CK− being capable of driving a voltage level of the node Nb4 to rise causes the transistor Q5 to turn on and charges the capacitor CL2. Therefore, no matter what voltage level the clocks CK+ and CK− are outputting, the load capacitor CL2 is capable of being charged due to one of the transistors being turned on until each capacitor is saturated.

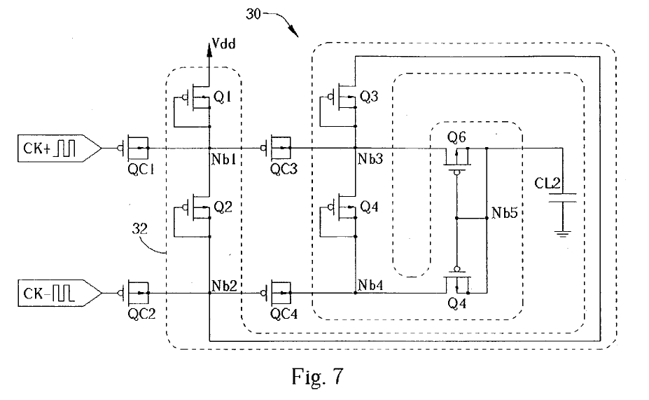

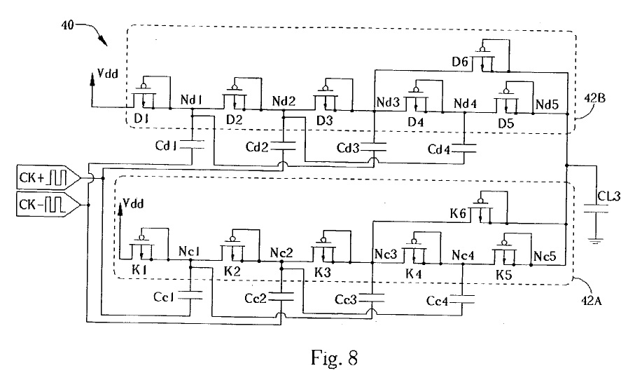

Please refer to FIG. 7 of a circuit schematic diagram based on the charge pump 30 shown in FIG. 6 taking actual transistors as charge units. The capacitors Cb1 to Cb4 shown in FIG. 6 as charge units are implemented as p-type MOS transistors QC1 to QC4 shown in FIG. 7, respectively. Each gate of the transistors QC1 to QC4 is one electrode of each capacitor and each source connecting with each drain is the other electrode of the capacitor. As formerly discussed, because each capacitor does not store too much charge, each capacitor comprised of a transistor is suitable for a charge unit.

Please refer to FIG. 8. FIG. 8 is a schematic diagram of a charge pump 40 of another embodiment of the present invention. The charge pump 40 comprises two current-guiding circuits 42A and 42B. The current-guiding circuit 42A, being a current-guiding unit, is a diode-type comprising transistors K1, K2, K3, K4, K5, and K6. Nodes Nc1, Nc2, Nc3, and Nc4 are output ends connecting to capacitors Cc1, Cc2, Cc3, and Cc4 respectively. Node Nc5 is a load output end connecting to a capacitor CL3. A voltage across the capacitor CL3 is an output voltage that the charge pump 40 is capable of providing. As with FIG. 6, the transistor K6 of FIG. 8 connects between Nc3 and Nc5.

Similarly, the current-guiding circuit 42B is a current-guiding unit of a diode-type comprising transistors D1, D2, D3, D4, D5, and D6. Nodes Nd1, Nd2, Nd3, and Nd4 are output ends connecting to capacitors Cd1, Cd2, Cd3, and Cd4 respectively. Node Nd5 is another load output end and connects to the capacitor CL3. The nodes Nc1, Nc2, Nd1, and Nd2 are connected to the capacitors Cc3, Cc2, Cd3, and Cd4, respectively. It is worth noticing that clock CK+ controls the two current-guiding circuits 42A and 42B via the capacitors Cc1 and Cd2 respectively. The clock CK− connects electrically to the two current-guiding circuits 42A, 42B via the capacitors Cc2 and Cd1.

For example, during the charging of each charge unit to steady-state, while CK+ is at the high voltage level and CK− is at the low voltage level, voltages on the nodes Nc3 and Nd4 rise by CK+ making the transistors K6 and D5 charge the load capacitor CL3 simultaneously. While CK+ is at the low voltage level and CK− is at the high voltage level, voltages on the nodes Nc4 and Nd3 rises to make the transistors K5 and D6 charge the load capacitor CL3 until charge in each charge unit reaches steady-state. In this way, during charging of each charge unit to steady-state, during a period of a clock transition between a high voltage level and a low voltage level, two transistors conduct current to charge the capacitor CL3 in the first half period and also two transistors conduct current to charge the capacitor CL3 in the second half period.

Furthermore, as illustrated above, a charge pump usually provides a high output voltage for a drive voltage to drive the tunnel-effect in the flash writing or erase processes. In the actual operation, charge pumps not only provide a high output voltage, but also a current-driving ability. In other words, the load capacitor CL3 can drive a current, and results in charge-loss and voltage-reduction across the capacitor CL3. At the moment that this occurs, the charge pump 40 can charge the capacitor CL3 again. Similar to the charge pumps 20 and 30, after the charge pump 40 shown in FIG. 8 stores charge at steady state, the highest voltage on the nodes Nc1 to Nc4 and Nd1 to Nd4 are identical to that on the nodes N1 to N4 in charge pump 20. After each capacitor stores charge at steady-state, for example, while a voltage across the capacitor CL3 reduces to 5 Vdd−6 Vt again, no matter which charge pump shown in FIG. 3 or FIG. 6, only the transistor M5 or Q5, which is closest to the load output, can charge the CL3 while the clock CK+ is at a high voltage level. In other words, in one period of the clock transition between the high voltage level and the low voltage level, only a half period is capable of charging the load capacitor.

For the charge pump 40 shown in FIG. 8, while the clock CK+ is at the high voltage level (in the first half period), a voltage on the node Nd4 is driven to 5 Vtt−4 Vt to turn on the transistor D5 to charge the capacitor CL3. While the clock CK+ is at the low voltage level (in the second half period), a voltage on the node Nc4 is driven by the clock CK−, which complements CK+, to 5 Vdd−4 Vt to turn on the transistor K5 to charge the capacitor CL3. In this case, in one cycle of the clock transitions between high voltage level and low voltage level, regardless if in the first half period or in the second half period, at least one transistor is capable of transferring a current to charge the capacitor CL3 to accelerate the voltage across the capacitor CL3 back to steady-state.

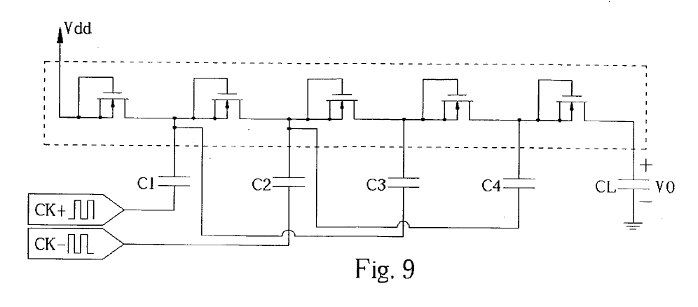

Please refer to FIG. 9. FIG. 9 illustrates another embodiment of the present invention. Besides the p-type MOS transistors used in FIGS. 3 to 8, n-type MOS transistor can also be used in the present invention. As the embodiment shown in FIG. 9, it works in the same way as the charge pump 20 in FIG. 3, except that diode-connected n-type MOS transistors are used as current-guiding units in the charge pump of FIG. 9.

In a conventional charge pump, each current-guiding unit comprised of n-type transistors causes not only a body-effect easily but also transistors get ruined due to over voltage differences. More seriously, each charge unit in the conventional charge pump is connected to the clock directly and requires a high-capacity stored charge to accumulate a high output voltage. The capacitor which stores the high-capacity stored charge is apt to be ruined from oxide layer breakdown and results in the charge pump being unable to work.

In contrast, the charge pump of the present invention utilizes p-type transistors, the body electrode of the p-type transistor, which is a n-well, can connect to the drain with a high voltage and is able to avoid a body-effect and to prevent transistor breakdown. The most important advantage is that the present invention utilizes a plurality of capacitors as charge units connecting serially to accumulate a high voltage, each single charge unit only storing a portion of the total charge. This avoids the capacitor as the charge unit breaking down and ensures normal operation of the charge pump of the present invention. Additionally, the present invention also discloses a variety of embodiments capable of accelerating the charge process, producing output voltage more quickly, and supplying charge more promptly.

Those skilled in the art will readily observe that numerous modifications and alterations of the device may be made while retaining the teachings of the invention. Accordingly, the above disclosure should be construed as limited only by the metes and bounds of appended claims.

What is claimed is:

1. A charge pump comprising:
a current-guiding circuit comprising:
a first output end, a second output end, and a third output end; and
a plurality of current-guiding units having a positive electrode and a negative electrode; wherein while a voltage on the positive electrode of the current-guiding unit is larger than a voltage on the negative electrode of the current-guiding unit by a predetermined amount, the current-guiding unit is capable of providing a current from the positive electrode; and while the voltage on the negative electrode of the current-guiding unit is larger than the voltage on the positive electrode of the current-guiding unit, the current-guiding unit is capable of preventing a current flowing from the negative electrode to the positive electrode; wherein the positive electrode and the negative electrode of a current-guiding unit are connected with the first output end and the second output end respectively; and the positive electrode and the negative electrode of another current-guiding unit are connected with the second output end and the third output end respectively; and
a first charge unit, a second charge unit, and a third charge unit; wherein each charge unit has two ends, the charge unit receiving a current from one of the two ends, storing corresponding charge from the current, and outputting voltage corresponding to the stored charge; and one end of the first charge unit connects with the first output end, one end of the second charge unit connects with the second output end, one end of the third charge unit connects with the third output end, and the other end of the third charge unit connects with the first output end resulting in an actual short circuit with the first output end;
wherein after the first charge unit stores charge, the voltage on the first output end connected with the third charge unit is actually different from the voltage on the first output end not connected with first charge unit.

2. The charge pump of claim 1 wherein each current-guiding unit is a diode.

3. The charge pump of claim 1 wherein each current-guiding unit is a transistor having a gate, a source being the positive electrode of the current-guiding unit, and a drain connected with the gate being the negative electrode of the current-guiding unit.

4. The charge pump of claim 3 wherein the transistor is a P-type metal oxide semiconductor (MOS)transistor.

5. The charge pump of claim 1 wherein the first, the second, and the third charge units are capacitors.

6. The charge pump of claim 5 wherein the capacitors comprise transistors.

7. The charge pump of claim 1 for providing an output voltage wherein the current-guiding circuit further comprises a load output end for being connected to a load unit, and another positive electrode and negative electrode for being connected to the third output end and the load output end respectively; wherein one end of the load unit connects with the output end and another end of the load unit connects with ground; and the load unit receives a current from one of two ends, stores corresponding charge from the current, and outputs a voltage corresponding to stored charge.

8. The charge pump of claim 7 wherein the current-guiding circuit has another current-guiding unit having a positive electrode connected with the second output end and, a negative electrode connected with the load output end.

9. The charge pump of claim 7 further comprising:
a second current-guiding circuit comprising:
a fourth output end, a fifth output end, a sixth output end, and a second load end; and
a plurality of current-guiding units having a positive electrode and a negative electrode; wherein while a voltage on the positive electrode of the current-guiding unit is larger than a voltage on the negative electrode of the current-guiding unit by a predetermined amount, the current-guiding unit is capable of providing a current from the positive electrode; and while the voltage on the negative electrode of the current-guiding unit is larger than the voltage on the positive electrode of the current-guiding unit, the current-guiding unit is capable of preventing a current flowing from the negative electrode to the positive electrode; wherein the positive electrode and the negative electrode of a current-guiding unit are connected with the fourth output end and the fifth output end respectively; and the positive electrode and the negative electrode of a current-guiding unit are connected with the fifth output end and the sixth output end respectively; and the positive electrode and the negative electrode of another current-guiding unit are connected with the sixth output end and the second load end respectively; and
a fourth charge unit, a fifth charge unit, and a sixth charge unit; wherein each charge unit has two ends, the charge unit receiving a current from one of the two ends, storing corresponding charge from the current, and outputting voltage corresponding to the stored charge; and one end of the fourth charge unit connects with the fourth output end, one end of the fifth charge unit connects with the fifth output end, one end of the sixth charge unit connects with the sixth output end, and the second load end connects with the load output end.

10. The charge pump of claim 9 wherein the other end of the sixth charge unit is connected with the fourth output end.

11. A charge pump for providing an output voltage comprising:
a current-guiding circuit comprising:
a first output end and a second output end;
a load output end for being connected with a load unit, the load unit receiving a current from the load output end, storing corresponding charge from the current, and outputting voltage corresponding to the stored charge to the load output end;
a plurality of current-guiding units, each current-guiding unit having a positive electrode and a negative electrode; wherein while a voltage on the positive electrode of the current-guiding unit is larger than a voltage on the negative electrode of the current-guiding unit by a predetermined amount, the current-guiding unit is capable of providing a current from the positive electrode; and while the voltage on the negative electrode of the current-guiding unit is larger than the voltage on the positive electrode of the current-guiding unit, the current-guiding unit is capable of preventing a current flowing from the negative electrode to the positive electrode; wherein the positive electrode and the negative electrode of a current-guiding unit are connected with the first output end and the second output end respectively; and the positive electrode and the negative electrode of another current-guiding unit are connected with the first output end and the load output end respectively; and
a first charge unit and a second charge unit, each charge unit having two ends, the charge unit receiving a current from one of the two ends, storing corresponding charge from the current, and outputting voltage corresponding to the stored charge; wherein one end of the first charge unit connects with the first output end, and one end of the second charge unit connects with the second output end.

12. The charge pump of claim 11 wherein each current-guiding unit is a transistor having a gate, a source being the negative electrode of the current-guiding unit, and a drain connected with the gate being the negative electrode of the current-guiding unit.

13. The charge pump of claim 3 wherein the transistor is a N-type metal oxide semiconductor (MOS)transistor.

14. The charge pump of claim 11 wherein the current-guiding circuit further comprises a third output end, and the current-guiding circuit has a current-guiding unit having a positive electrode and a negative electrode that are connected with the third output end and the first output end respectively, the charge pump further comprising:
a third charge unit having two ends, and for receiving a current from one of the two ends, storing corresponding charge from the current, and outputting voltage corresponding to stored charge; wherein one end of the third charge unit connects with the third output end; and one end of the second charge unit, without being connected with the second output end, is connected with the third output end.

15. The charge pump of claim 11 further comprising:
a second current-guiding circuit comprising:
a fourth output end, a fifth output end, and a second load end; and
a plurality of current-guiding units, each current-guiding unit having a positive electrode and a negative electrode; wherein while a voltage on the positive electrode of the current-guiding unit is larger than a voltage on the negative electrode of the current-guiding unit by a predetermined amount, the current-guiding unit is capable of providing a current from the positive electrode; and while the voltage on the negative electrode of the current-guiding unit is larger than the voltage on the positive electrode of the current-guiding unit, the current-guiding unit is capable of preventing a current flowing from the negative electrode to the positive electrode; wherein the positive electrode and the negative electrode of a current-guiding unit are connected with the fourth output end and the fifth output end respectively; and the positive electrode and the negative electrode of another current-guiding unit are connected with the fifth output end and the second load end respectively; and
a fourth charge unit, and a fifth charge unit, wherein each charge unit has two ends, the charge unit receiving a current from one of the two ends, storing corresponding charge from the current, and outputting voltage corresponding to the stored charge; wherein one end of the fourth charge unit connects with the fourth output end; and one end of the fifth charge unit connects with the fifth output end; and the second load end connect with the load output end.

16. The charge pump of claim 15 wherein the second current-guiding circuit has a current-guiding unit having a positive electrode connected with the fourth output end and a negative electrode connected with the second load output end.

17. The charge pump of claim 15 wherein the second current-guiding circuit further comprises a sixth output end, and the second current-guiding circuit has a current-guiding unit having a positive electrode and a negative electrode that are connected with the sixth output end and the fourth output end respectively; and the charge pump further comprises a sixth charge unit having two ends, and for receiving a current from one of the two ends, storing corresponding charge from the current, and outputting voltage corresponding to stored charge; wherein one end of the sixth charge unit connects with the sixth output end; and one end of the fifth charge unit, without being connected with the fifth output end, is connected with the sixth output end.

18. The charge pump of claim 11 wherein each current-guiding unit is a diode.

19. The charge pump of claim 18 wherein each diode is composed of a P-type metal-oxide-semiconductor (MOS) transistor.

20. The charge pump of claim 18 wherein each diode is composed of a N-type metal-oxide-semiconductor (MOS) transistor.
